(19) United States
(12) Patent Application Publication
(10) Pub. No.: US 2009/0230034 A1
(43) Pub. Date: Sep. 17, 2009

(54) FILTER CARTRIDGE

(76) Inventors: Justin R. Darnell, Olive Branch, MS (US); Lazar S. Geller, Germantown, TN (US); Jeffrey C. Stewart, Bartlett, TN (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/402,522

(22) Filed: Mar. 12, 2009

Related U.S. Application Data
(60) Provisional application No. 61/036,616, filed on Mar. 14, 2008.

(51) Int. Cl. B01D 35/14

(52) U.S. Cl. 210/100

(57) ABSTRACT

A filter cartridge includes a fuse element (500) that closes an exit door (502) when an inlet-outlet pressure differential rises to a range corresponding to a clogged filter media. The fuse element (500) comprises a plastic poppet (540) that remains staged on a podium (520) during normal operation. An increase in inlet pressure and/or a decrease in outlet pressure pushes the poppet (540) away from the podium (520) and positions it to seal the exit door (502).

### RELATED APPLICATION

This application claims priority under 35 U.S.C. §119 (e) to U.S. Provisional Patent Application No. 61/036,616 filed on Mar. 14, 2008. The entire disclosure of this provisional application is hereby incorporated by reference. If incorporated-by-reference subject matter is inconsistent with subject matter expressly set forth in the written specification (and/or drawings) of the present disclosure, the latter governs to the extent necessary to eliminate indefiniteness and/or clarity-lacking issues.

### FIELD

A filter cartridge comprising filter media with an inner radial surface defining an outlet chamber therewithin and an outer radial surface defining an inlet chamber therearound.

### BACKGROUND

A refueling system for an aircraft can generally comprise a hydrant (or other almost continuous source of fuel), and a vehicle that transfers fuel from the hydrant to the aircraft. A transfer vehicle (e.g., a cart or truck) can comprise, for example, a supply hose from the hydrant to its accouterment bank, and a delivery hose from the bank to the aircraft. The accouterment bank can comprise, among other things, a filter assembly for filtering the fuel prior to its delivery to the aircraft.

### SUMMARY

A filter cartridge comprises a fuse element that shuts the fuel exit should the filtering media become clogged or otherwise fail to pass fluid at an acceptable flow rate. The fuse element comprises a plastic poppet part that “blows” in response to the inlet-outlet pressure differential reaching a range corresponding to a filter-clogged scenario. The fuse element can be constructed without electrical circuits, biasing springs, complicated mechanical linkages, and/or precision instrumentation. Thus, the fuse element can be economically incorporated into a replaceable filter cartridge and, once the poppet has “blown”, it can be discarded with the filter cartridge and replaced.

### DRAWINGS

FIG. 1 is a schematic diagram of a refueling system for an aircraft.

FIGS. 2A and 2B are side and top views, respectively, of a filter assembly for the refueling system.

FIG. 3 is a side view (with the filter media partially removed) of a fuse-filter cartridge of the filter assembly.

FIGS. 4A-4C are schematic views of the operation of the cartridge's fuse element, and FIGS. 4D-4J are close-up views take from these schematics.

FIG. 5 is a perspective sectional view of the fuse element (and adjacent regions of a filter element) without its movable poppet part.

FIGS. 6A and 6B are perspective views of the movable poppet part.

### DESCRIPTION

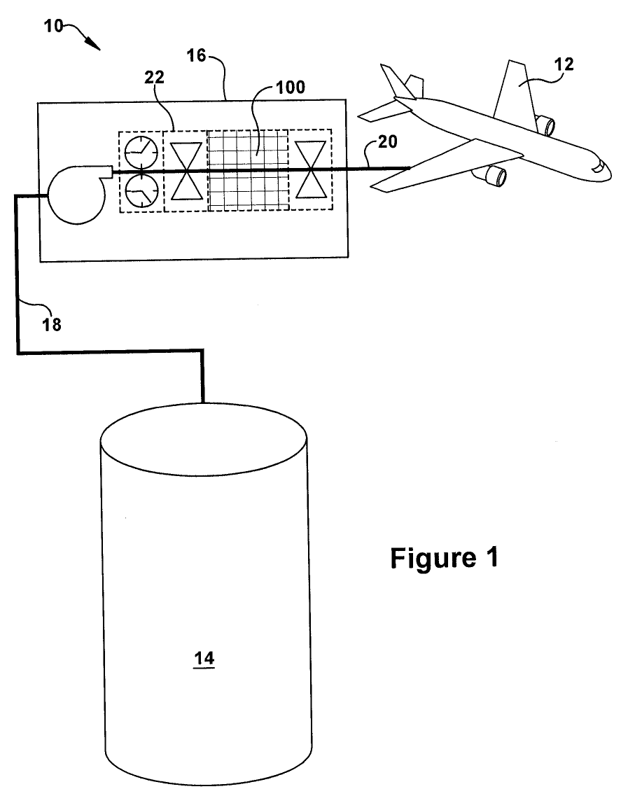

Turning now to the drawings, and initially to FIG. 1, a refueling system 10 for an aircraft 12 is schematically shown. In this system 10, aviation fuel from a hydrant 14 (or other almost continuous source) is supplied to a transfer vehicle 16 (e.g., via a supply hose 18) which then delivers the fuel to the aircraft 12 (via a delivery hose 20). The vehicle's accouterment bank 22 includes, among other things, a filter assembly 100, which filters the fuel prior to its delivery to the aircraft 12.

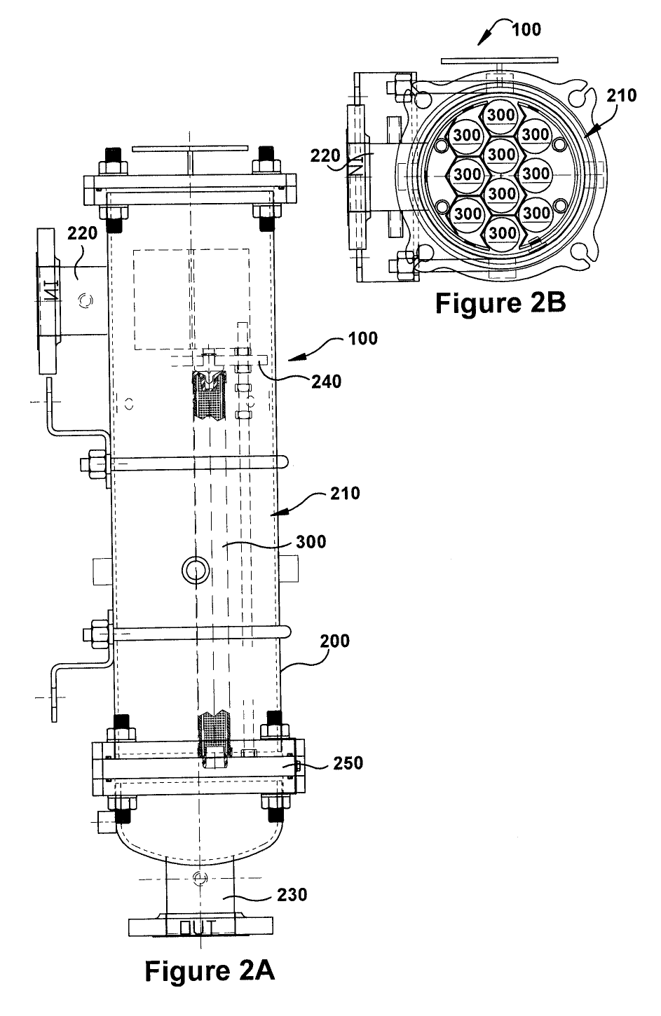

The filter assembly 100 is shown in FIGS. 2A and 2B isolated from the rest of the refueling system 10. The filter assembly 100 includes a housing 200 and at least one filter cartridge 300 installed therein. The housing 200 of a refueling filtering assembly 100 will often house a plurality of filter cartridges 300 (e.g., at least two, at least four, at least six, at least eight, and/or at least ten cartridges 300), as in the illustrated embodiment.

The housing 200 includes a capsule 210, an inlet pipe 220 extending radially thereinto, and an outlet pipe 230 extending axially therefrom. An inlet scaffold 240, and an outlet scaffold 250 can be suspended inside the capsule 200 to support opposite ends (i.e., the inlet end and the outlet end, respectively) of the filter cartridges 300. The inlet scaffold 240 (or other analogous structure) allow fuel introduced through the inlet pipe 220 to flow around the circumferences of the filter cartridges 300. The outlet scaffold 250 (or other analogous structure) allows only filtered fuel exiting the cartridges 300 to flow to the outlet pipe 230.

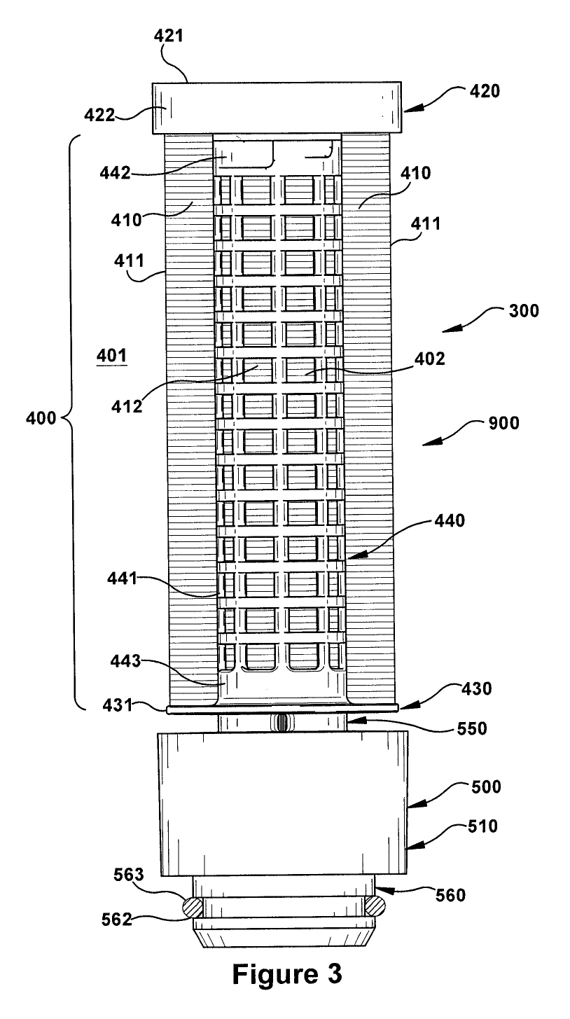

Referring now to FIG. 3, the filter cartridge 300 generally comprises a filter element 400 and a fuse element 500. A filter manufacturer can fabricate the filter element 400 and the fuse element 500 as an integral cartridge, which is supplied as a unit to an end user. That being said, a filter cartridge 300 compiled from separately manufactured and/or supplied elements 400/500, is possible and contemplated.

The filter element 400 defines an inlet chamber 401 and an outlet chamber 402, with the inlet chamber 401 communicating with the inlet pipe 220 in the filter assembly 100. The filter element 400 can comprise a cylindrical pack of filtering media 410 having an outer radial face 411 defining the inlet chamber 401 therearound, and an inner radial face 412 defining the outlet chamber 402 therewithin. The media 410 can be formed from, for example, one or more layers of filtration material folded into pleats and then shaped into the cylindrical pack.

The filter element 400 additionally comprises a first end cap 420, a second end cap 430, and a center sleeve 440. The first end cap 420 comprises a circular wall 421 bonded to and sealing the adjacent axial face of the filtering media 410, and also closing the adjacent end of the outlet chamber 402. (The illustrated cap 420 also includes a radial rim 422 surrounding the wall 421.) The second end cap 430 comprises an annular wall 431 bonded to a sealing the adjacent axial face of the filtering media 410, and leaving open the adjacent end of the outlet chamber 402. The center sleeve 440 includes a cage-like cylindrical wall 441 having a first hem 442 attached to the first end cap 420, and a second hem 443 attached to the second end cap 430.

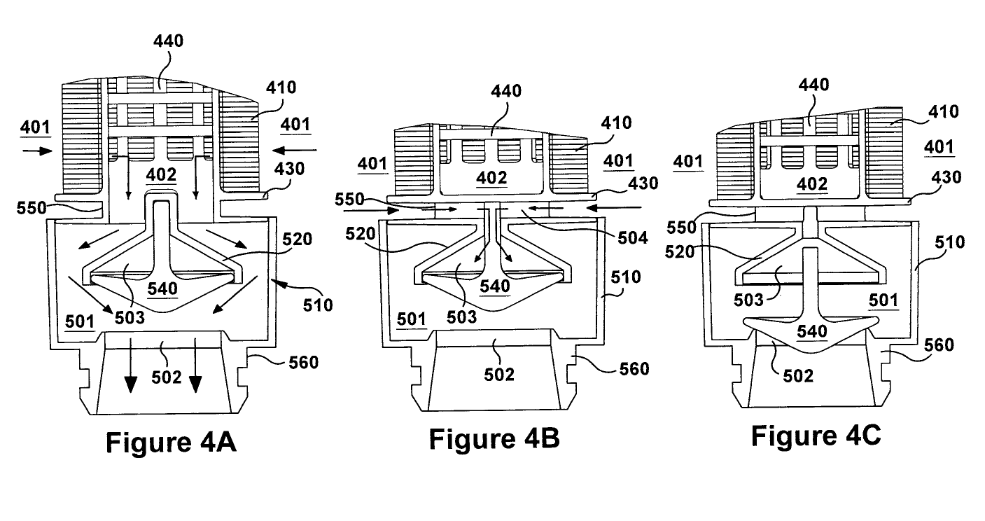

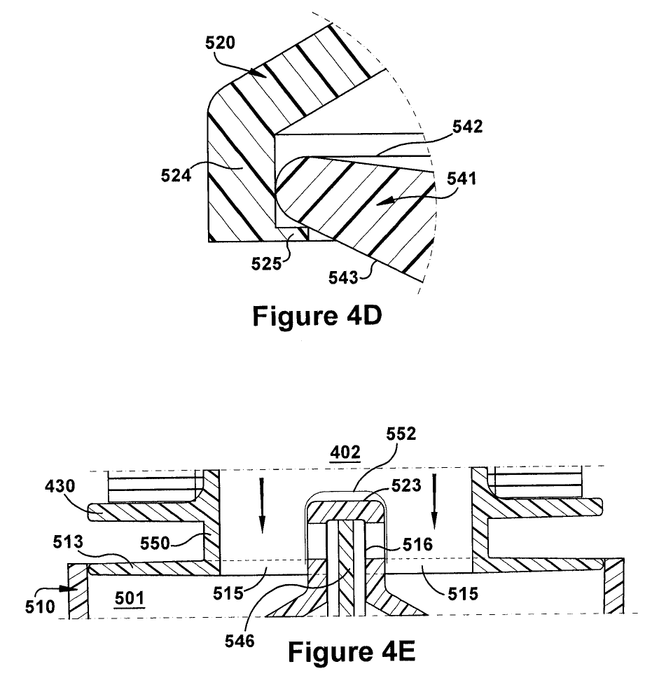

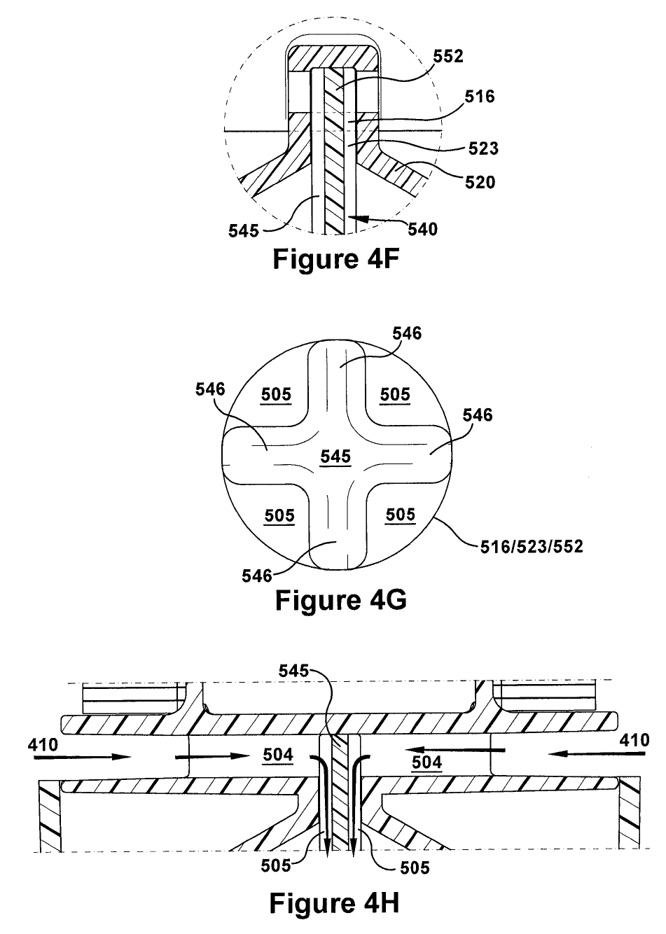

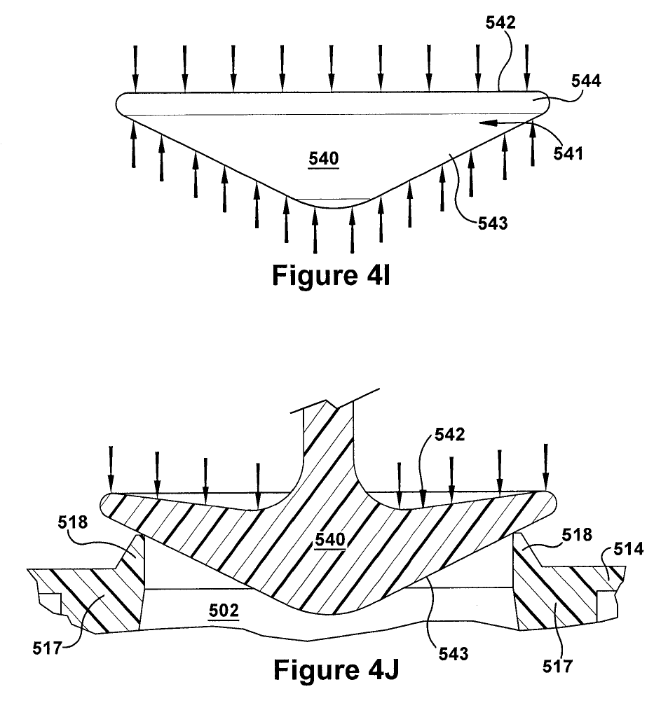

The fuse element 500 is perhaps best explained by first referring to FIGS. 4A-4C. The fuse element 500 can generally comprise a canister 510, a poppet podium 520, a poppet 540, a corridor 550, and an exit annex 560. These components together define an exit chamber 501, an exit door 502, a fuse-monitoring chamber 503, and fuse-monitoring channels 504. The exit chamber 501 communicates with the outlet chamber 402 of the filter element 400. The exit door 502 communicates with the housing's outlet pipe 230. The fuse-monitoring chamber 503 communicates, via the channels 504, with the inlet chamber 401 of the filter element 400 (See FIG. 4B).

The poppet 540 is movable from an open position (FIGS. 4A and 4B) to a closed position (FIG. 4C). When the filter cartridge 300 is installed, and during normal operation thereof, the poppet 540 is in its open position. When the fuse element 500 is “blown”, the poppet 540 moves to, and remains in, its closed position.

When the poppet part 540 is in its opened position, it separates the pre-exit chamber 501 from the monitoring chamber 503. Filtered fluid flows from the outlet chamber 402 to the pre-exit chamber 501 and then through the exit door 502. (See arrows in FIG. 4A.) And not-yet filtered fluid flows from the inlet chamber 401 to, and is trapped within, the fuse chamber 503. (See arrows in FIG. 4B.) It may be noted for future reference that fluid pressure within the pre-exit chamber 501 will correspond to that of the outlet chamber 402 and fluid pressure within the fuse-monitoring chamber 503 will correspond to that of the inlet chamber 401. Thus, the fluid pressure within the monitoring chamber 503 will be less than that within the pre-exit chamber 501. (Assuming there is a pressure drop across the filtering media 410, which almost always occurs.)

When the poppet part 540 is in its closed position, it seals the exit door 502. (FIG. 4C.) The outlet chamber 402 still communicates with the exit chamber 501, but fluid cannot pass through the exit door 502 to the housing outlet pipe 230. The inlet chamber 401 still communicates with the monitoring chamber 503. The poppet part 540 no longer separates the chambers 501 and 503, whereby they communicate with each other. But again, any fluid flowing into the exit chamber 501 is trapped therein because the poppet 540 closes the exit door 502. It may be noted for future reference that fluid pressure inside the chamber 503 corresponds to a mix of fluid from both the inlet chamber 401 and the outlet chamber 402, while fluid pressure outside the exit door 502 corresponds to that of the outlet chamber 402 alone.

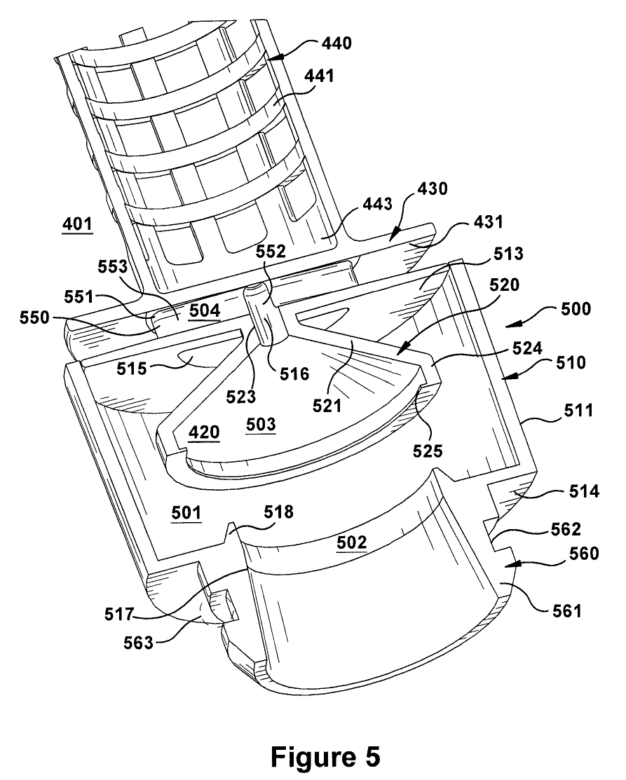

Referring additionally to FIG. 5, the fuse element 500 is shown without its movable poppet 540. The canister 510 comprises a cylindrical side wall 511, a first axial wall 513, and a second axial wall 514, that define the confines of the exit chamber 501. The first axial wall 513 has an array of fluid slots 515 that communicate with the exit chamber 501, and a stem-receiving opening 516 (that does not communicate with the exit chamber 501). The second axial wall 514 has an inner radial edge 517 defining the exit door 502, and an axial shoulder 518 surrounding this edge 517.

The poppet podium 520 has a dome-shaped side wall 521, tapering axially away from the canister's wall 513, and defining the fuse-monitoring chamber 503. The wall 521 has a central stem-receiving opening 523 on its peak that is coextensive with the canister's stem-receiving opening 516. A rim 524 can surround the base of the side wall 521, and a lip 525 can extend radially inward from the rim 524. The rim 524 and/or the lip 525 define an open end of the podium 420.

The corridor 550 comprises a cylindrical side wall 551 extending between the adjacent end cap 430 of the filter element 400 and the adjacent wall 513 of the canister 510. An internal corridor wall forms a stem-receiving opening 552 that is coextensive with canister/podium openings 516/523, and these openings 516/523/552 together form a passageway into the fuse-monitoring chamber 503. Internal walls 553 form tunnels in the corridor 550 extending through the cylindrical side wall 551 and to the stem-receiving opening 552. These tunnel-forming walls 553 define the monitoring channels 504, and connect the inlet chamber 401 to the monitoring chamber 503 (via the openings 516/523/552). The space within the cylindrical side wall 551, and not occupied by the internal walls 552/553, communicates with the exit chamber 501 via the fluid slots 5165 in the canister 510.

The exit annex 560 can comprise a cylindrical wall 561 extending axially away from the adjacent canister wall 514 and/or the exit door 502. A circumferential groove 562 can be formed in the wall 561, for receipt of a sealing member 563 (e.g., an O-ring). In the filter assembly 100, exit annex 560 would be received in an opening in the housing scaffold 250 (See FIG. 2A), and the sealing member 563 would seal the interface therebetween.

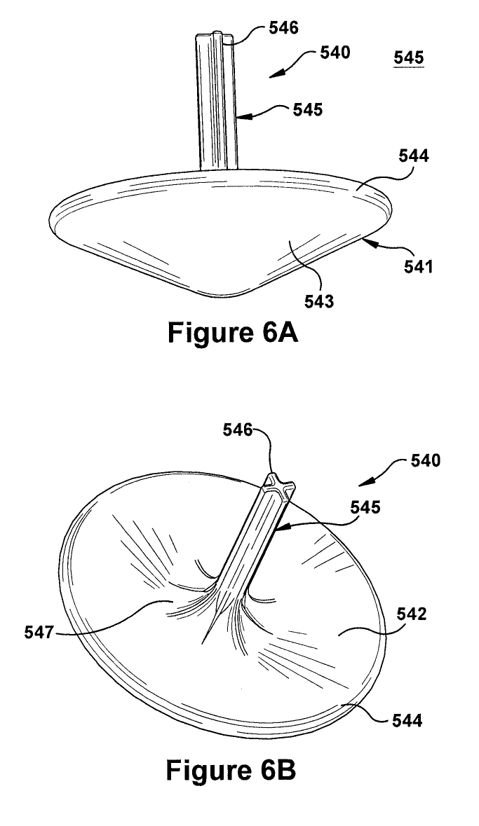

The poppet 540, shown alone in FIGS. 6A and 6B, can comprise an conical head 541 having an inlet-pressure side 542, an outlet-pressure side 543, and radial rim 544 extending therearound. In the illustrated embodiment, the inlet-pressure side 542 is relatively flat and the outlet-pressure side 543 has a conical contour, whereby the side 543 has a greater surface area. A stem 545 can extend axially from the inlet-pressure side 542 of the head and have axial ridges 456 formed thereon. Umbrella-like webs 547 can span between the poppet's head 540 and its stem 545.

Returning now to FIGS. 4A-4B, and also FIGS. 4D-4J, the poppet 540 is initially staged within podium 520 with its head 541 captured by the canister's lip 525. (FIG. 4D.) Filtered fuel from the outlet chamber 402 flows into the corridor 550, through the canister slots 515, and into the exit chamber 501. (FIG. 4E.) As the exit door 502 is open (e.g., not blocked by the poppet 540), fluid in the exit chamber 501 exits therethrough. (FIG. 4A.) The poppet head 541 prevents fluid from inside the monitoring chamber 503 from entering the exit chamber 501, whereby only filtered fluid from the outlet chamber 402 flows through the open exit door 502.

The poppet's stem 545 is received within the openings 552/523/516 in the corridor 550, the podium 520, and the canister 510. (FIG. 4E.) Referring not to FIG. 4G, the openings' circular diameters are sized and shaped to closely hug the outer perimeter of the stem 545, and its ridges 546 form tunnels 505 through the openings 552/523/515. Unfiltered (and higher pressure) fluid from the inlet chamber 401 flows through channels 504 to the tunnels 505. (FIG. 4H.) Thus, inlet-pressure fluid fills the monitoring chamber 503. (FIG. 4B.)

When the poppet 540 is in its open position, inlet-pressure fluid within the monitoring chamber 503 pushes its side 542 toward the exit door 502 and outlet-pressure fluid within the exit chamber 501 pushes its side 543 in the opposite direction away from the exit door 502. (FIG. 4I.) The poppet 540 is additionally confined by capture of its head 541 by the podium lip 525 and the press-fit connection of its stem 545 in the openings 516/523/552. (FIGS. 4D and 4E.) During normal operation, the push of the inlet-pressure fluid within the monitoring chamber 503 is not sufficient to overcome the opposite outlet-pressure push, the lip capture, and/or the press-fit connection.

However, should the filter media 510 become clogged (for example), the inlet pressure would rise and/or the outlet pressure would drop, thereby increasing the pressure differential between the inlet chamber 401 and the outlet chamber 402. With a rise in pressure differential, the push of the inlet-pressure fluid within the monitoring chamber 503 becomes strong enough to overcome the outlet-pressure fluid in the exit chamber 501, to bend the podium lip 525 in a releasing direction, and to dislodge the stem 545 from its press-fit connection.

The poppet 540 accordingly moves from its open position to its closed position, whereas it seals the exit door 502. (FIG. 4C.) In this position, the poppet's side 543 is braced against the canister shoulder 518. (FIG. 4J.) Fluid from both the inlet chamber 401 and the outlet chamber 402 communicate with the exit chamber 501 whereby the fluid pushes against side 542 of the poppet at a pressure greater than the outlet-pressure. This fluid pressure securely holds the poppet 460 against the shoulder 518 during continued operation of the filter assembly 100 (e.g., with other non-clogged cartridges). The size/shape of the poppet head 541 prevents it from escape through the exit door 502.

Significantly, the filter cartridge 300 and/or the fuse element 500 does not provide a bypass or alternate exit path upon closing of the exit door 502. In a filter assembly 100 housing a single cartridge 300, this would result in halt in exit flow, thereby providing an indication that the filter cartridge 300 needs to be replaced. In a filter assembly 100 housing a plurality of filter cartridges 300, exit flow would continue from the remaining filter cartridges.

The poppet 540 and its staging within the podium 520 are thus designed so that the poppet 540 remains in its open position until a pressure differential between the inlet chamber 401 and the outlet chamber 402 reaches a predetermined range corresponding to clogging of the filter media 410. The “blow” point of the fuse element 500 can be altered by adjusting the relative surface areas between inlet-pressure side 542 and the outlet-pressure side 543 of the poppet head 540. Additionally or alternatively, the capture strength of the podium lip 525 can be modified and/or the press-fit stem connection can be changed. But, in any event, the fuse element 500 can be constructed without electrical circuits, biasing springs, complicated mechanical linkages, and/or precision instrumentation.

Referring now to FIG. 5, in the illustrated embodiment, the center sleeve 440, the second end cap 430, the corridor 550, the canister's axial wall 513, and the poppet podium 520 can be formed in one piece. For example, they can be molded from a polymeric material. To assembly the filter cartridge 300, the filter media 410 would be inserted around the sleeve 440 and the non-integral end cap 420 bonded thereto to seal the filter element 400. The poppet 540 (separately molded from a polymeric material), would then inserted into the podium 520, its stem 545 press-fit into the openings 516/523/552, and the lip 525 bent around its head 541. After installation of the poppet 540, the rest of the canister 510 (e.g., its walls 511 and 514) would be attached to the wall 513 to close the exit chamber 501. The exit annex 560 can be formed in one piece with the canister walls 511/514, or formed separately and attached thereto.

Although the filter assembly 100, the cartridge 300, the filter element 400, and/the fuse element 500 has been shown and described with respect to a certain embodiments, equivalent alterations and modifications should occur to others skilled in the art upon review of this specification and drawings. If an element (e.g., component, assembly, system, device, composition, method, process, step, means, etc.), has been described as performing a particular function or functions, this element corresponds to any functional equivalent (i.e., any element performing the same or equivalent function) thereof, regardless of whether it is structurally equivalent thereto. And while a particular feature may have been described with respect to less than all of embodiments, such feature can be combined with one or more other features of the other embodiments.

1. A filter cartridge comprising:
a filter element including filter media having an inner radial surface defining an outlet chamber therewithin and an outer radial surface defining an inlet chamber therearound;
a fuse element including a poppet in an open position and movable to a closed position when a pressure differential between the inlet chamber and the outlet chamber reaches a predetermined range corresponding to clogging of the filter media; and
an exit that communicates with the outlet chamber when the poppet is in its open position and is sealed from the outlet chamber when the poppet is in its closed position.

2. A filter cartridge as set forth in claim 1, characterized by the filter cartridge not having an alternate exit path upon sealing of the exit.

3. A filter cartridge as set forth in claim 2, wherein the filter element comprises an exit chamber communicating with the outlet chamber of the filter element and a fuse-monitoring chamber communicating with the inlet chamber of the filter element; and
wherein, when the poppet is an open position, it separates the exit chamber from the monitoring chamber, and filtered fluid flows from the outlet chamber to the exit chamber and then through the exit door.

4. A filter cartridge as set forth in claim 1, wherein the fuse element further comprises a canister that defines an exit chamber in communication with the outlet chamber and a podium that defines a fuse-monitoring chamber in communication with the inlet chamber.

5. A filter cartridge as set forth in claim 4, wherein the poppet is staged within the podium when it is in an open position.

6. A filter cartridge as set forth in claim 5, wherein the poppet includes a stem and, when the poppet is in its open position, the stem is press-fit into coextensive openings in the canister and the podium.

7. A filter cartridge as set forth in claim 5, wherein the poppet includes a head having a first side and a second side;
wherein, when the poppet is in its open position, the first side is subjected to fluid pressure within the fuse-monitoring chamber and the second side is subjected to fluid pressure within the exit chamber.

8. A filter cartridge as set forth in claim 1, wherein the poppet is formed in one piece.

9. A filter cartridge as set forth in claim 1, wherein the poppet is made of plastic.

10. A filter cartridge as set forth in claim 1, wherein the poppet comprises a head having an inlet-pressure side and an outlet-pressure side, and a stem extending axially from its head's inlet pressure side, and wherein the stem is press-fit into a canister of the fuse cartridge.

11. A filter cartridge as set forth in claim 1, wherein the fuse element includes a canister defining an exit chamber communicating with the outlet chamber; and a podium defining a fuse-monitoring chamber communicating within the inlet chamber;
wherein the fuse-monitoring chamber is situated within exit chamber; and
wherein the poppet is staged on the podium when in its open position.

12. A filter cartridge as set forth in claim 11, wherein the filter element includes an end cap bonded to an axial face of the filter media, and wherein the end cap and a wall of the canister are formed in one piece.

13. A filter cartridge as set forth in claim 12, wherein the filter element includes a center sleeve, also formed in one piece with the end cap and the wall of the canister.

14. A filter cartridge as set forth in claim 13, wherein the podium is also formed in one piece with the center sleeve, the end cap, and the wall of the canister.

15. A filter cartridge as set forth in claim 14, wherein the fuse element further comprises a corridor between the end cap and the canister, and wherein the corridor is also formed in one piece with the podium, the center sleeve, the end cap, and the wall of the canister.

16. A filter cartridge as set forth in claim 14, wherein the podium, the center sleeve, the end cap, and the wall of the canister are molded from a polymeric material.

17. A filter cartridge as set forth in claim 11, wherein the podium and a wall of the canister are formed in one piece.

18. A filter assembly comprising a housing and a filter cartridge as set forth in claim 1 installed in the housing, the housing comprising an inlet hose communicating with the inlet chamber of the filter cartridge and an outlet hose communicating with the exit of the filter cartridge.

19. A filter assembly comprising a housing and a plurality of filter cartridges as set forth in claim 1 installed in the housing, the housing comprising an inlet hose communicating with the inlet chambers of the filter cartridges and an outlet hose communicating with the exits of the filter cartridges.

20. A refueling system for an aircraft comprising the filter assembly set forth in claim 19.
